(19) United States
(12) Patent Application Publication
(10) Pub. No.: US 2006/0119068 A1
(43) Pub. Date: Jun. 8, 2006

(54) Driving apparatus of multifunctional chain bicycle

(76) Inventor: Min Young Hee, Kyunggi-do (KR)

Correspondence Address: LADAS & PARRY LLP, 224 SOUTH MICHIGAN AVENUE, SUITE 1600, CHICAGO, IL, 60604, US

(21) Appl. No.: 11/094,779

(22) Filed: Mar. 30, 2005

(30) Foreign Application Priority Data
Dec. 8, 2004 (KR) 10-2004-0102740

(51) Int. Cl. B62M 1/02

(52) U.S. Cl. 280/260

(57) ABSTRACT

Disclosed herein is a driving apparatus of a multifunctional chain bicycle. In the driving apparatus, components of its forward driving arrangement to permit forward motion of the bicycle with either forward or reverse rotation of bicycle's pedals are arranged on the right side of a bicycle's rear wheel shaft and on the right side of a pedal shaft, and components of both stair climbing pedaling arrangement and pedal positional arrangement are arranged on the left side of the pedal shaft and on a left pedal arm.

### BACKGROUND OF THE INVENTION

1. Field of the Invention

The present invention relates to a chain bicycle capable of realizing various pedaling modes.

2. Description of the Related Art

Bicycle riding is excellent exercise. Vigorous biking is wonderful for general body health in that it produces increased heart pumping to supply increased blood to the large leg muscles. There is not the constant leg impact associated with jogging.

In the basic bicycle design, a rear wheel of the bicycle is driven by a bicycle chain through a chain sprocket powered by a pedal shaft driven by the legs and feet of the bicyclist operating on a pair of bicycle pedals attached to the pedal shaft.

For the typical bicycle to move in a forward direction, the bicyclist applies force to the pedals causing them to rotate in the same rotational direction as a front wheel of the bicycle for forward motion. This rotational direction is hereinafter referred to as the “forward direction”, and an opposite rotational direction is hereinafter referred to as the “reverse direction”. Accordingly, the rotational direction of all components of the bicycle will be explained as the forward or reverse direction.

As one kind of currently used typical bicycles, U.S. Pat. No. 5,918,894 discloses a bicycle to permit a forward force to be applied to a bicycle's drive wheel by reverse rotation of bicycle's pedals in addition to permitting a forward force to be applied to the drive wheel by forward rotation of said pedals while allowing the pedals to rotate in various modes. The disclosed bicycle comprises: arranged on the right side of a pedal shaft, a forward driving arrangement consisting of a combination of spur gears or bevel gears and two one-way clutches associated with pedal sprockets and serving to permit forward motion of the bicycle with either forward or reverse rotation of the pedals; a stair climbing pedaling arrangement using a single one-way clutch, a plurality of bevel gears and a control disc; and a pedal positional arrangement to permit the pedals to be selectively positioned relative to each other. The disclosed bicycle configured as stated above allows the bicyclist to rotate the pedals in various modes.

However, the prior art bicycle, which realizes a variety of pedaling modes as stated above, has a problem in that a distance between both the pedals is relatively wide because all the above mentioned three arrangements, namely, the forward driving arrangement, the stair climbing pedaling arrangement, and the pedal positional arrangement, are arranged on the right side of the pedal shaft, requiring excessive outstretching of the bicyclist's legs when pedaling. Further, with such a configuration, the right pedal is extremely protruded outward in a lateral direction of the bicycle as compared to the left pedal, causing one of the bicyclist's legs to be excessively outstretched far away from the bicycle as compared to the other leg. This makes it impossible for the bicyclist to effectively apply a force to the pedals when the bicyclist pedals up an incline, and makes it difficult to pedal the bicycle in general.

### SUMMARY OF THE INVENTION

Therefore, the present invention has been made in view of the above problems, and it is an object of the present invention to provide a chain bicycle in which components of its forward driving arrangement to permit forward motion of the bicycle with either forward or reverse rotation of bicycle's pedals are arranged on the right side of a bicycle's rear wheel shaft and on the right side of a pedal shaft, and components of both stair climbing pedaling arrangement and pedal positional arrangement are arranged on the left side of the pedal shaft and on a left pedal arm, thereby allowing a bicyclist to easily operate the pedals in various modes without excessively outstretching his/her legs.

In accordance with the present invention, the above and other objects can be accomplished by the provision of a driving apparatus of a multifunctional chain bicycle comprising: a forward driving arrangement to permit forward motion of the bicycle with either forward or reverse rotation of bicycle's pedals, all components of the forward driving arrangement being arranged on the right side of a bicycle's rear wheel shaft and on the right side of a pedal shaft; and a stair climbing pedaling arrangement and a pedal positional arrangement arranged on the left side of the pedal shaft and on a left pedal arm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the overall structure of a bicycle driving apparatus according to a preferred embodiment of the present invention;

FIG. 2 is an illustrative view of a variety of pedaling modes by a forward driving arrangement;

FIG. 3 is a perspective view of another preferred embodiment of the present invention to implement a kangaroo stroke;

FIGS. 4a and 4b are perspective views of a foot holder device attached to a pedal, FIG. 4a illustrating a horizontal inverted state of the foot holder device, and FIG. 4b illustrating a vertical erected state of the foot holder device;

FIG. 5 is an illustrative view of a variety of pedaling positions associated with the kangaroo stroke;

FIG. 6 is a sectional view concretely illustrating components arranged on the left side of a pedal shaft;

FIG. 7 is an illustrative view of a variety of pedaling modes by a stair climbing pedaling arrangement and a pedal positional arrangement;

FIG. 8 is a partially cut-away exploded perspective view illustrating the stair climbing pedaling arrangement and the pedal positional arrangement in association with the pedal shaft;

FIG. 9 is a perspective view illustrating receiving spaces defined in a positional disc;

FIG. 10 is an exploded perspective view of the stair climbing pedaling arrangement and the pedal positional arrangement;

FIG. 11 is an exploded perspective view of the stair climbing pedaling arrangement and the pedal positional arrangement shown in FIG. 10, which are partially shown in a coupled state; and

FIG. 12 is a sectional view of the stair climbing pedaling arrangement and the pedal positional arrangement.

### DESCRIPTION OF THE PREFERRED EMBODIMENTS

Now, preferred embodiments of the present invention will be explained with reference to the accompanying drawings.

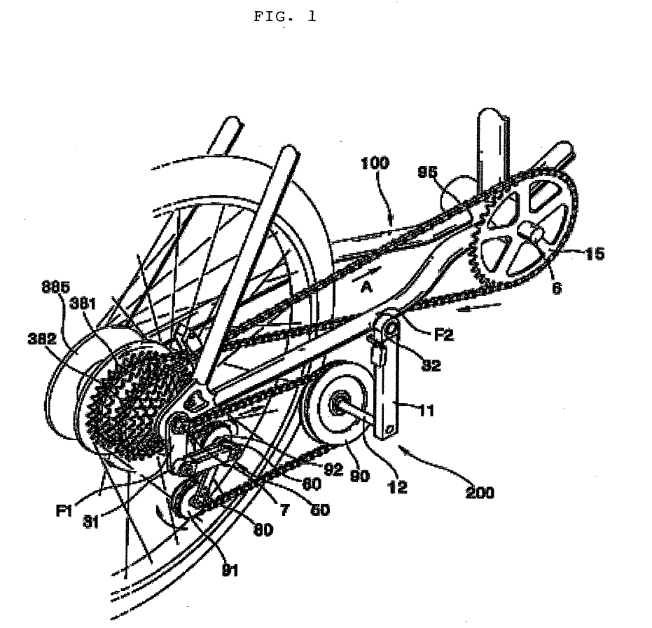

Referring to FIG. 1 illustrating a driving apparatus of a chain bicycle according to a preferred embodiment of the present invention, the driving apparatus comprises: a stair climbing pedaling arrangement 100 and a pedal positional arrangement 200 which selectively determines relative positions of pedals 2 and 3, arranged on the left side of a pedal shaft 6 and on a left pedal arm 4; and a forward driving arrangement 300 to permit forward motion of the bicycle with either forward or reverse rotation of the pedals 2 and 3 and arranged on the right side of a rear wheel shaft 380 and on the right side of the pedal shaft 6.

Similar to conventional chain bicycles, the pedals 2 and 3, namely, the left pedal 2 and the right pedal 3 are attached to both ends of the pedal shaft 6, respectively, via the left pedal arm 4 and a right pedal arm 5. Front and rear wheels (not shown) are fixedly mounted, respectively, on a not shown front and a rear wheel hub 385. The rear wheel hub 385 is fixedly mounted on the rear wheel shaft 380 via bearings so as to rotate in a forward or reverse direction. Here, the bearings are shown in FIG. 1 but are not designated by reference numerals. A pedal sprocket 15 is fixedly mounted on the pedal shaft 6.

First and second rear wheel sprockets 381 and 382, as shown in FIG. 1, are arranged on a right end of the rear wheel shaft 380 by interposing first and second one-way clutches 383 and 384, respectively. In turn, the first and second one-way clutches 383 and 384 are mounted on the rear wheel shaft 380 so as to freely rotate in either forward or reverse direction via bearings, which are shown in FIG. 1 but are not designated by reference numerals. The one-way clutches 383 and 384 are known clutches and adapted to rotate simultaneously while being caught in only a forward direction.

The first one-way clutch 383 comes into fixedly contact at its one end with the rear wheel hub 385 while being fixed in the forward direction, and the second one-way clutch 384 comes into contact at its one end with the other end of the first one-way clutch 383 while being fixed in the forward direction.

An idler roller 90 is rotatably attached to a bicycle frame (not shown) near the rear wheel. An endless chain 95 is looped around the pedal sprocket 15 as well as the first and second rear wheel sprockets 381 and 382 and the idler roller 90. The pedal arms 4 and 5 are affixed to the pedal shaft 6 to rotate along with the pedal shaft 6.

With such a configuration as described above, when the pedal shaft 6 rotates in a forward direction F with forward rotation of the pedals 2 and 3, the endless chain 95 transmits power in an order of the top of the pedal sprocket 15, the bottom of the sprocket 15, the top of the first rear wheel sprocket 381, the bottom of the sprocket 381, the bottom of the idler roller 90, the top of the roller 90, the bottom of the second rear wheel sprocket 382, the top of the sprocket 382, and the top of the pedal sprocket 15 as an original starting point.

On the other hand, when the pedal shaft 6 rotates in an opposite reverse direction with reverse rotation of the pedals 2 and 3, the endless chain 95 transmits power in an order of the top of the pedal sprocket 15, the top of the second rear wheel sprocket 382, the bottom of the sprocket 382, the top of the idler roller 90, the bottom of the roller 90, the bottom of the first rear wheel sprocket, the top of the sprocket 381, the bottom of the pedal sprocket 15, and the top of the pedal sprocket 15 as an original starting point.

When the pedal sprocket 15 rotates in the forward direction by such a forward pedaling, and thus rotates the endless chain 95 in the forward direction F, the second rear wheel sprocket 382 rotates in the forward direction and the first rear wheel sprocket 381 rotates in the reverse direction. Thereby, the second rear wheel sprocket 382 rotates the rear wheel hub 385, on which the not shown rear wheel is fixedly mounted, in the forward direction via the second one-way clutch 384 and subsequently the first one-way clutch 383. In this case, the first rear wheel sprocket 381 freely rotates on the first one-way clutch 383.

Conversely, in the case of a reverse pedaling, the first rear wheel sprocket 381 rotates the rear wheel hub 385, on which the not shown rear wheel is fixedly mounted, in the forward direction via the first one-way clutch 383. In this case, the second rear wheel sprocket 382 freely rotates on the second one-way clutch 384 in the reverse direction.

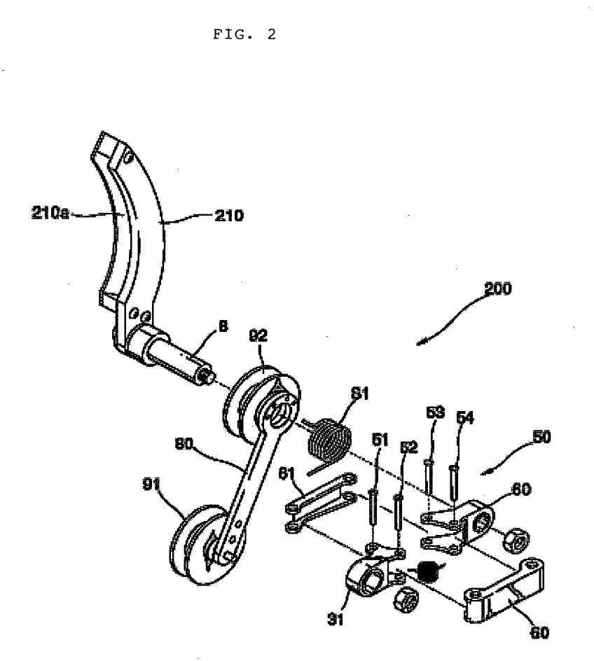

In this way, the driving apparatus of the present invention allows a bicyclist to implement forward motion of the bicycle with either forward or reverse rotation of the pedals 2 and 3. The ways in which the bicycle can be pedalled with the driving apparatus of the present invention include forward pedaling, reverse pedaling, scissors left side, and scissors right side (see FIG. 2).

Kangaroo Stroke

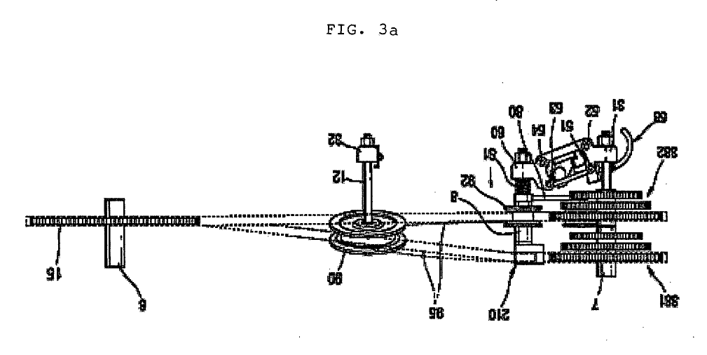

FIG. 3 shows a slightly different embodiment using the same parts as shown in FIGS. 1 and 2. The present embodiment differs from the previous embodiment only in the position of the pedal arms 4 and 5.

As shown in FIG. 3, both the pedal arms 4 and 5 are parallel to each other and point upward of the bicycle. The pedal arms 4 and 5 are affixed to the pedal shaft 6.

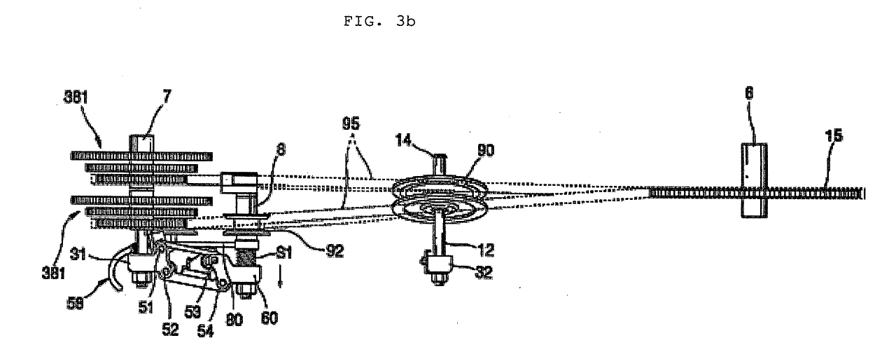

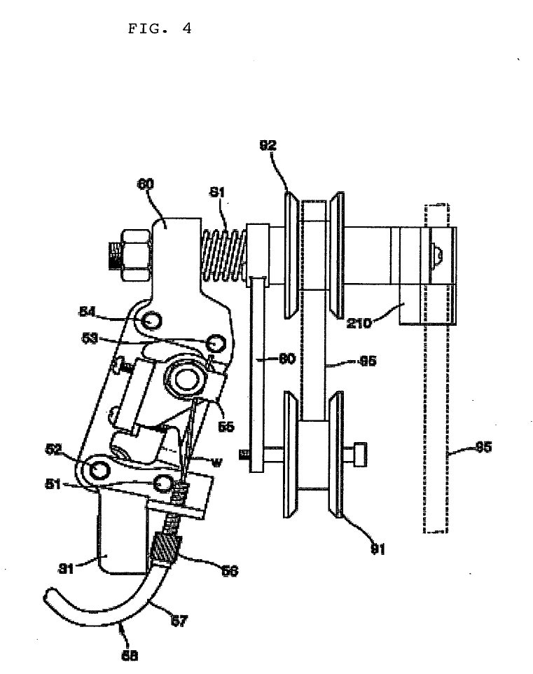

In the present embodiment, the bicyclist's shoes should be firmly attached to the pedals 2 and 3 while ensuring easy detachment therefrom. Now, a structure to firmly attach the shoes to the pedals will be explained with reference to FIGS. 4a and 4b.

FIGS. 4a and 4b illustrate a foot holder device 400 attached to the pedal 2 or 3.

As shown in FIGS. 4a and 4b, the foot holder device 400 comprises a first fixing shaft 401 fixedly mounted at its one end to an upper end of the pedal arm 4 or 5 to protrude outward in a lateral direction of the pedal arm 4 or 5, and a rectangular pedal base 402 rotatably coupled to the first fixing shaft 401.

The foot holder device 400 further comprises a holder base 410 having a shape and size to surround three side walls of the pedal base 402 except for a side wall where a strap 420 to be explained hereinafter will be disposed. The first fixing shaft 401 rotatably penetrates through one side wall of the holder base 410, and a second fixing shaft 403 rotatably penetrates through the opposite side wall of the holder base 410. The second fixing shaft 403 is also fixedly mounted to the pedal base 402. Thereby, the holder base 410, made of a heavy material, such as steel, is supported by means of both the fixing shafts 401 and 403.

A spring 403a is coiled around the second fixing shaft 403. In a state wherein one end of the coil spring 403a is affixed to the pedal base 402 and the other end thereof is affixed to the holder base 410, the spring 403a causes both the strap 420 and the holder base 410 to rotate about the second fixing shaft 403 in a reverse pedaling direction. Further, in order to limit rotating motion of the strap 420 and the holder base 410 in the reverse pedaling direction, a stopper 404 protrudes outward from an outer side wall of the pedal base 402 and serves to restrictively permit rotation of the holder base 410 and the strap 420 between a horizontal inverted state and a vertical erected state.

The foot holder device 400 further comprises the strap 420. One end of the strap 420 is coupled to an end of the side wall of the holder base 410, penetrated by the first fixing shaft 401, through female-male coupling, and the other end of the strap 420 is coupled to an end of the opposite side wall of the holder base 410 penetrated by the second fixing shaft 403 so as to be readily released in a direction regardless of any pedaling motion (i.e. in a direction toward the not shown rear wheel in the erected state of the holder base 410 shown in FIG. 4b). The strap 420 is made of plastic and is centrally provided with a known length adjuster 425 to allow the overall length of the strap 420 to be adjusted suitable to surround the shoe disposed on the pedal 2 or 3.

Now, a means to permit the other end of the strap 420 to be readily released from the end of the opposite side wall of the holder base 410, penetrated by the second fixing shaft 403, in the direction toward the rear wheel will be explained with reference to FIG. 4b showing the erected state of the holder base 410.

The end of the opposite side wall of the holder base 410 penetrated by the fixing shaft 403 is provided with a box-shaped receiving member 411, which is opened toward the not shown rear wheel and is closed in an opposite direction in the erected state of the holder base 410. A plate spring 412 is affixed to an outer wall 411a of the receiving member 411 by means of fasteners. The outer wall 411a of the receiving member 411 centrally defines a slot 414 so that a cylindrical insert 413 is tightly mounted in the slot 414 to occupy part of the interior space of the receiving member 411. In such a mounted state, the cylindrical insert 413 is affixed to the plate spring 412 to be pressed thereby. The interior space of the receiving member 411 has a shape and size corresponding to the other end of the strap 420 to be fitted therein. This allows the other end of the strap 420 to be easily and readily released from the end of the opposite side wall of the holder base 410, penetrated by the second fixing shaft 403, in the direction toward the not shown rear wheel in the erected state of the holder base 410. Alternatively, a known snap-lock means, which is releasable by only a force acting in an outward direction of the pedal, may be used to permit ready release of the strap 420.

The foot holder device 400 further comprises an inverted holder base keeper unit 430, which is elastically fitted in a cavity S defined in the pedal base 402 to penetrate through the outer side wall of the pedal base 402 defining the cavity S and be latched into a recess 405 defined in an inner wall surface of the side wall of the holder base 410 penetrated by the fixing shaft 403. Such an inverted holder base keeper unit 430 includes a cylindrical post 431, a first rod 432, a spring 433, a second rod 434, and a third rod 435. The first rod 432 is fixedly attached at its one end to a circumferential position of the cylindrical post 431, and the other end of the first rod 432 extends opposite to the cylindrical post 431 to penetrate through a partition wall of the pedal base 402 defining the cavity S. A spring 433 is coiled around the first rod 432 between the partition wall and the cylindrical post 431. The second rod 434, having a rectangular cross section, is fixedly attached at its one end to a circumferential position of the cylindrical post 431, and the other end of the second rod 434 extends opposite to the first rod 432 so as to penetrate through the outer side wall of the pedal base 402 defining the cavity S. The second rod 434 is integrally formed with a limiter piece 436 to limit the protrusion of the other end thereof out of the pedal base 402. The third rod 435 vertically penetrates through a spring 436 vertically inserted in the interior space of the hollow cylindrical post 431 so as to be elastically extendible from the top of the cylindrical post 431. When the holder base 410 is moved from its vertical erected state to its horizontal inverted state, the second rod 434 comes into contact with the rim of the recess 405 at a cam surface 434a formed at the other end thereof. The cam surface 434a is shaped and sized to allow the second rod 434 to move back by a repulsive force of the cam surface 434a against the rim of the recess 405, thereby causing the other end of the second rod 434 to be released from the recess 405.

With such a foot holder device 400 configured as stated above, if the bicyclist presses the third rod 435 toward the pedal arm 4 or 5 in the horizontal inverted state of the holder base 410, and thus the second rod 434 is released from the recess 405, the holder base 410 is pivotally rotated about the second fixing shaft 403, thereby being erected by a force of the spring 403a. The erected state of the holder base 410 is continuously maintained by the spring 403a and the stopper 404. Then, in the erected state of the holder base 410, if the bicyclist presses the strap 420 coupled to the holder base 410 toward the not shown front wheel by his/her foot, the holder base 410 is pivotally rotated about the second fixing shafts 403, thereby being inverted against the force of the spring 403a. In this case, the pressed second rod 434 is again inserted into the recess 405 of the holder base 410 upon receiving a compression force of the spring 433, thereby permitting the inverted state of the holder base 410 to be continuously maintained. In this way, the bicyclist can stably operate the pedal 2 or 3 in either vertical erected or horizontal inverted state of the pedal base 410 by pressing the third rod 435 provided at the pedal 2 or 3.

When the bicyclist simultaneously pushes down on the pedals 2 and 3 and pulls up on the pedals 2 and 3 under assistance of the foot holder device 400, the power from the pedals 2 and 3 is transmitted to the not shown rear wheel by forward kangaroo pedaling and reverse kangaroo pedaling. In particular, when the bicyclist rotates the pedals 2 and 3 in a forward direction, the pedal shaft 6 affixed to the pedal arms 4 and 5 rotates in the forward direction. Such forward rotation of the pedal shaft 6 causes the rear wheel to rotate in the forward direction. When the bicyclist rotates the pedals 2 and 3 in a reverse direction, the pedal shaft 6 affixed to the pedal arms 4 and 5 rotates in the reverse direction. The reverse rotation of the pedal shaft 6 also causes the rear wheel to rotate in the forward direction.

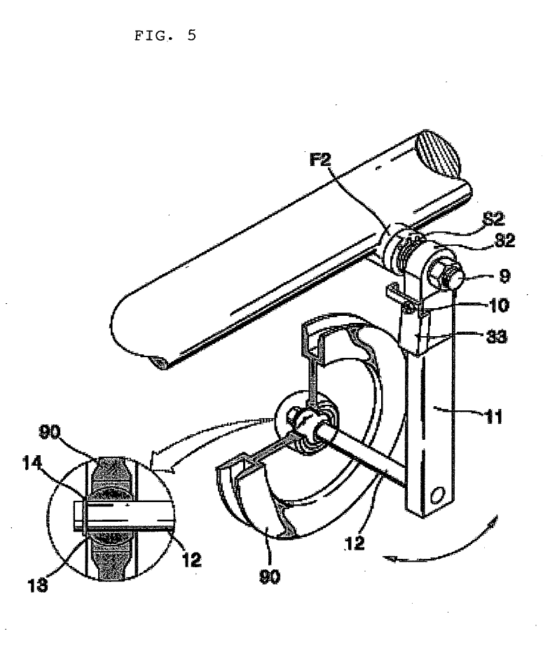

With the present embodiment, the bicyclist can pedal in a variety of modes, such as forward kangaroo pedaling, reverse kangaroo pedaling, and rocker down pedaling, as shown in FIG. 5.

Stair Climbing

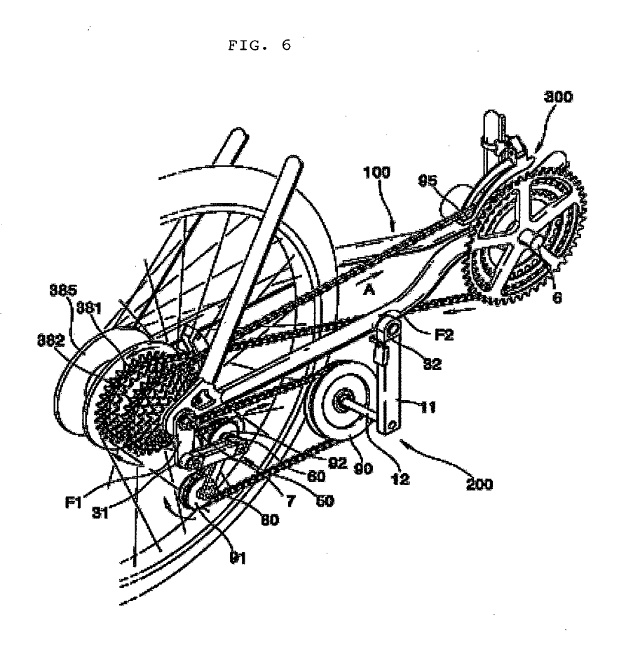

FIGS. 1 and 6 illustrate the stair climbing pedaling arrangement 100 in accordance with the preferred embodiment of the present invention. The stair climbing pedaling arrangement 100 cooperates with the forward driving arrangement 300, arranged on the right side of the pedal shaft 6 as shown in FIG. 1, so as to permit forward bicycle motion when the pedals 2 and 3 simultaneously rotate in opposite directions through an alternating reciprocating pedal motion.

In the present embodiment, the pedal shaft 6 is extended leftward with an adaptor so that the stair climbing pedaling arrangement 100 can be added. Components added on the left side of the pedal shaft 6 are first and second sprockets 32 and 34, and components added to a not shown frame are first and second idler rollers 40 and 41.

The first and second idler rollers 40 and 41 cooperate respectively with the first and second sprockets 32 and 34 via a single endless chain 35. The idler rollers 40 and 41 rotate on respective reversing shaft 42 and 43, which are vertically spaced apart from each other and rotate within bearings 44 and 45 mounted, at vertically spaced positions, on the not shown frame. The first sprocket 32 is fixed on the pedal shaft 6, and the second sprocket 34 is freely rotatable on the pedal shaft 6 via a bearing 36.

The endless chain 35 is looped around the sprockets 32 and 34 and the idler rollers 40 and 41 in an order of the top of the first sprocket 32, the bottom of the first idler roller 40, the top of the roller 40, the top of the second sprocket 34, the bottom of the sprocket 34, the top of the second idler roller 41, the bottom of the roller 41, the bottom of the first sprocket 32 and the top of the first sprocket 32 as an original starting position. With such a configuration, the first and second sprockets 32 and 34 rotate in opposite directions.

The left pedal arm 4 freely rotates on the pedal shaft 6 via a bearing 47. Since the sprockets 32 and 34, which rotate in opposite directions, are mounted on the pedal shaft 6, when one of the pedals is rotated in a direction, the other pedal is simultaneously rotated in an opposite direction, even if both the pedals 2 and 3 are not simultaneously rotated in opposite directions. The first sprocket 32 cooperates with the second sprocket 34 via the endless chain 35, and as shown in FIG. 6, the sprocket 34 is affixed to the pedal arm 4 by means of a fitting 38. Thereby, the right pedal 3 rotates in the same direction as the pedal shaft 6, whereas the left pedal 2 rotates in the opposite direction of the pedal shaft 6.

Under assistance of the stair climbing pedaling arrangement 100 configured as stated above, the bicycle can move forward by an alternating pedal reciprocating stroke. The present embodiment is excellent for stair climbing type leg motion to exercise gluteal and greater hamstring muscles in addition to the other leg muscles.

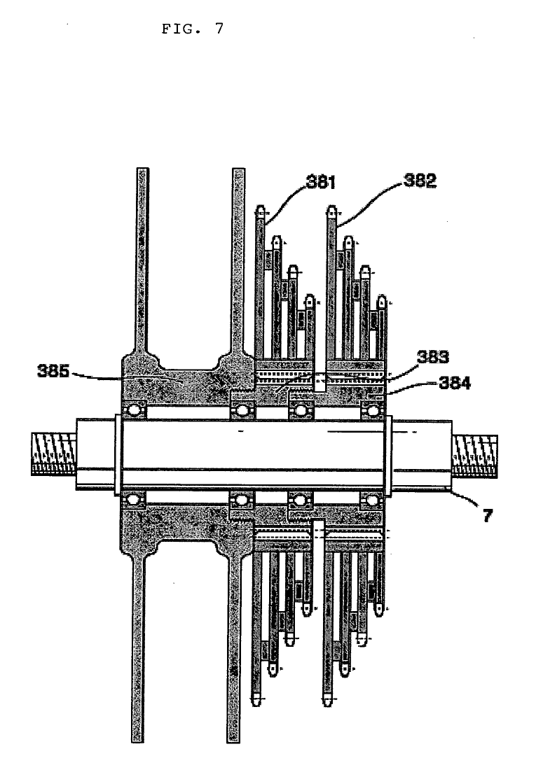

Using this embodiment of the invention, the bicyclist can pedal the bicycle in the following modes: parallel alternating front, parallel alternating back, halfmoon alternating down, counter-rotational right, counter-rotational left, stair climbing forward, stair climbing backward, bi-directional right side and bi-directional left side (see FIG. 7).

Explaining the above description in more detail, with the configuration of FIGS. 1 and 3, forward and reverse rotating motions of the pedal arm 5 fixed on the pedal shaft 6 causes the not shown rear wheel to rotate forward, resulting in forward motion of the bicycle.

Referring to FIGS. 1, 3 and 6, when the left pedal arm 4 rotates in a forward direction, the second sprocket 34 simultaneously rotates in the forward direction via the fitting 38 which operatively connects the left pedal arm 4 with the sprocket 34. The forward rotation of the second sprocket 34 causes the first sprocket 32 to rotate in a reverse direction via the single endless chain 35 and the two idler rollers 40 and 41. Since the sprocket 32 is fixed on the pedal shaft 6, the pedal shaft 6 is simultaneously rotated in the reverse direction with the first sprocket 32. In this way, the pedal arm 4, which rotates on the pedal shaft 6 via the bearing 47, rotates in the opposite direction of the pedal shaft 6. Such reverse rotation of the pedal shaft 6 causes the pedal sprocket 15 to rotate in the reverse direction. Thereby, the second rear wheel sprocket 382 is rotated in the reverse direction, and the first rear wheel sprocket 381 is rotated in the forward direction via the endless chain 95. With the forward rotation of the first rear wheel sprocket 381, the one-way clutch 383 is latched to the associated first rear wheel sprocket 381, so as to drive the rear wheel hub 385 in the forward direction and consequently the not shown rear wheel in the forward direction.

When the left pedal arm 4 rotates in a reverse direction, the second sprocket 34 simultaneously rotates in the reverse direction via the fitting 38. The reverse rotation of the second sprocket 34 causes the first sprocket 32 to rotate in a forward direction via the single endless chain 35 and the two idler rollers 40 and 41, and the pedal shaft 6, to which the sprocket 32 is fixed, is simultaneously rotated in the forward direction. With such forward rotation of the pedal shaft 6, the one-way clutch 384 is latched to the associated second rear wheel sprocket 383, so as to drive the rear wheel hub 385 in the forward direction and consequently the not shown rear wheel in the forward direction.

With the present embodiment, the bicyclist can drive the bicycle forward by alternately performing forward and reverse strokes with a respective one of the pedals 2 and 3 (i.e. by stair climbing pedaling).

Relative Pedal Positions

Persons skilled in the art will note that, in all of the embodiments of the present invention discussed above, the two pedals rotate at the same speed either in the same direction or different directions. In either case the relative starting positions can be important. These starting positions can be established in a wide variety of ways such as fixing the pedal arm 4 and 5 at specific relative positions on the pedal shaft 6 or on the sprocket 34.

Remote Adjustment of Pedal Position and Relative Pedal Rotation

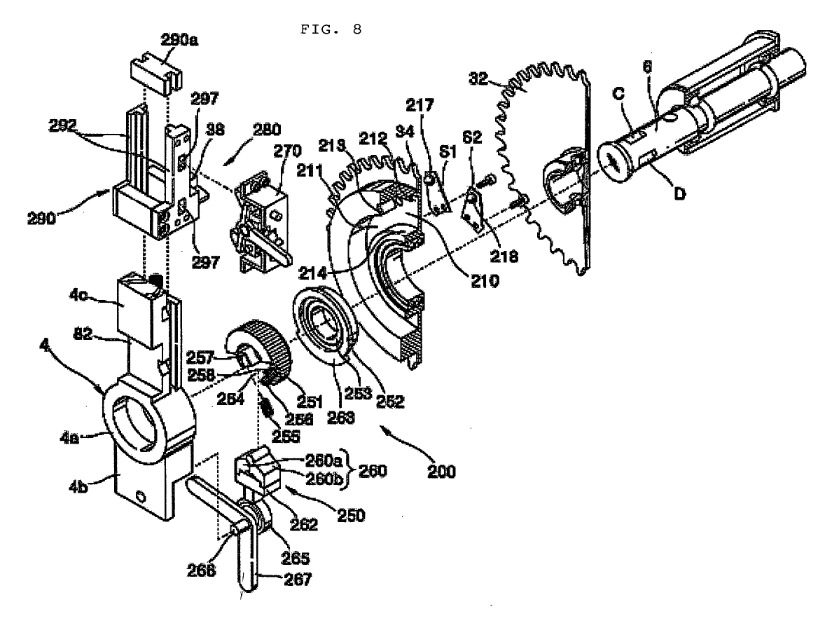

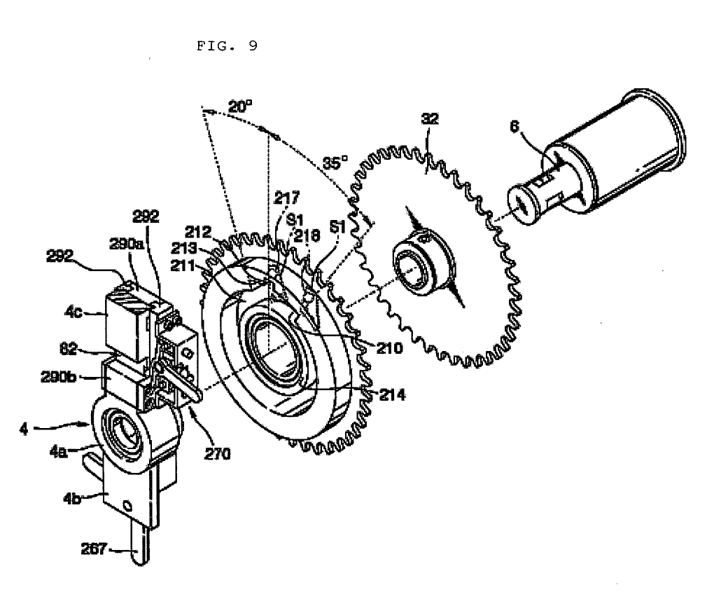

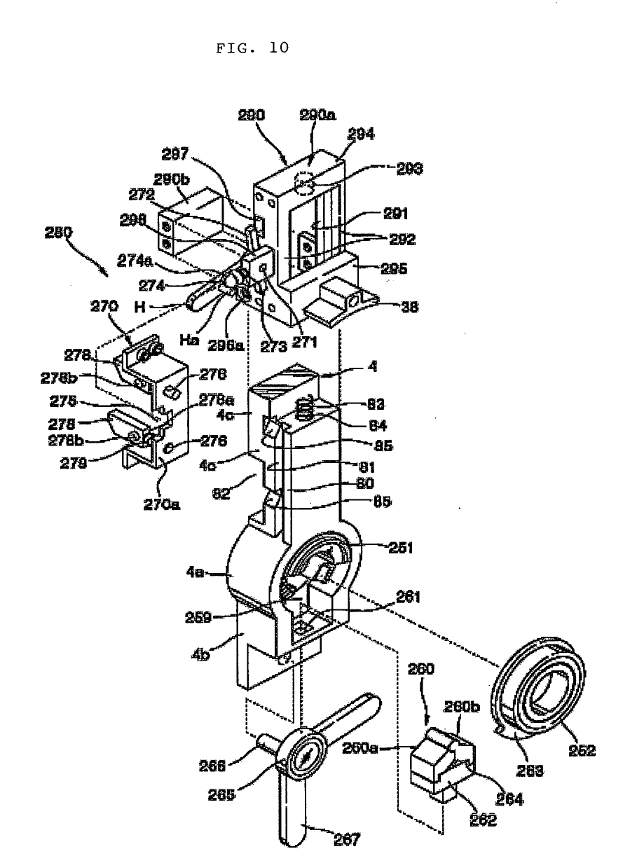

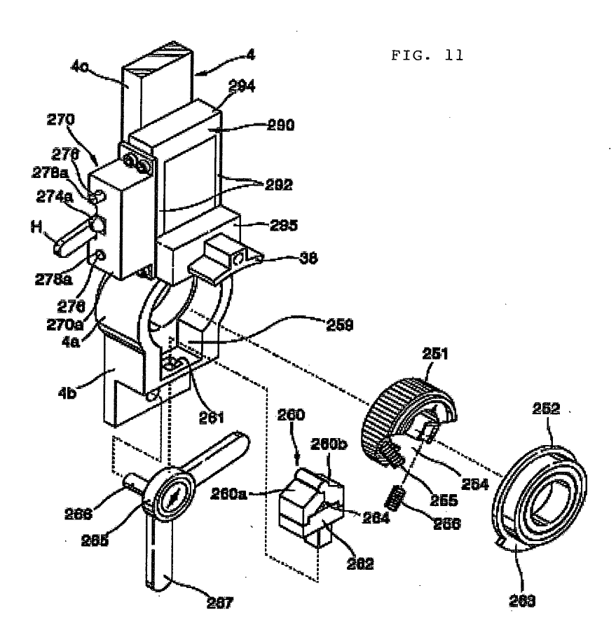

It is feasible to provide for selection of relative pedal positions and relative direction of rotation at the will of the bicyclist while riding down the road. This can be done with the pedal positional arrangement 200 as is shown in FIGS. 1, 6, 8 to 12. The pedal positional arrangement 200 comprises a positional disc 210, a clutch mechanism 250, and a shifting mechanism 280 which is used to shift the fitting 38 in three stages in order to selectively position the fitting 38 at a predetermined position of the positional disc 210. The positional disc 210, as shown in FIGS. 6, 8 to 12, is fixed to the sprocket 34 so as to rotate freely on the pedal shaft 6.

The clutch mechanism 250 is provided at a base portion 4a of the pedal arm 4. The pedal arm 4 is adapted to rotate on the pedal shaft 6 separately from or simultaneously with the pedal shaft 6 via the clutch mechanism 250. The fitting 38 annexed to the pedal arm 4 is driven through operation of the shifting mechanism 280 also annexed to the pedal arm 4.

The positional disc 210, as shown in FIGS. 6, 8 and 9, has three receiving spaces to receive the fitting 38. The three receiving spaces, communicating with the sprocket 34, have the same center axis as that of the pedal shaft 6, but have different perimeters and different radial positions from one another.

Explaining concretely the three receiving spaces, they include a ring shaped first receiving space 211 positioned radially closest to the center axis of the pedal shaft 6, a second receiving space 212 positioned radially farthest to the center axis of the pedal shaft 6 and having a shape and size corresponding to that of the fitting 38, and an annular third receiving space 213 positioned in a radial halfway between the first receiving space 211 and the second receiving space 212. An imaginary line which extends, starting from a center point of the pedal shaft 6, over a forward end of the annular third receiving space 213 forms an angle between 15° and 25°, preferably, an angle of approximately 20°, with a bisector line which radially bisects the second receiving space 212, and an imaginary line which extends, starting from the center point of the pedal shaft 6, over a reverse end of the annular third receiving space 213 forms an angle larger than 25° but smaller than 45°, preferably, an angle of approximately 35°, with the bisector line. Here, the angle of approximately 20° is an angle defined in a forward pedaling direction, and the angle of approximately 35° is an angle defined in a reverse pedaling direction.

The positional disc 210 further has two radially-extending flat springs S1 and S2 fixed at their radial inner ends to a ring-shaped root portion 214 of the sprocket 34. Radial outer ends of the flat springs S1 and S2 are provided respectively with balls 217 and 218, and the balls 217 and 218 are configured to penetrate through respective holes formed at the sprocket 34 so as to protrude toward the fitting 38. The flat springs S1 and S2 are positioned, respectively, near both the ends of the third receiving space 213.

The clutch mechanism 250 is provided at a projecting portion 4b extending, in the opposite direction of the pedal 2, from the base portion 4a of the pedal arm 4, which is rotatably mounted on the pedal shaft 6 via the bearing 47. A spring containing case 251 is spline-coupled to an inner circumference of the base portion 4a and is fixed on the pedal shaft 6. In order to prevent unintentional separation of the spring containing case 251, a cover member 252 comes into contact with the spring containing case 251 and the base portion 4a, and is fastened to the base portion 4a by fasteners. In this way, the cover member 252 is rotatably mounted on the pedal shaft 6 via a bearing 253.

The spring containing case 251 is radially cut within a range of 90° relative to the center axis of the pedal shaft opposite to a region, where the pedal 2 will be mounted, to form an opening 254. Both ends of the case 251 defining the opening 254 are provided with bores 257 and 258 so that a pair of springs 255 and 256 are inserted therein. The springs 255 and 256 partially protrude from the bores 257 and 258 to face each other.

The projecting portion 4b of the pedal arm 4 is internally formed with a receiving space 259 which communicates with the opening 254 and receives a locking mechanism 260. In order to permit vertical movement of the locking mechanism 260, a locking rod 262 is also slidably received in the receiving space 259 so that one end thereof comes into contact with the locking mechanism 260 and the other end thereof protrudes out of the receiving space 259 through a hole 261 perforated at the projecting portion 4b. The hole 260 is to communicate the receiving space 259 with the outside.

In order to prevent the locking rod 262 from being separated from the locking mechanism 260, the cover member 252 is formed at part of an outer circumference thereof with a radially protruding separation-preventing piece 263.

The locking mechanism 260 is divided into two sections 260a and 260b, which are shaped and sized so that their distal ends are engaged with each other to form a seat portion 264 which will be tightly seated on the end of the locking rod 262. The other ends of the sections 260a and 260b are engaged with each other to form a specifically shaped and sized portion suitable to permit the locking mechanism 260 to be inserted into a selected one of plural semi-circular slits A, B, C and D formed on an outer circumference of the pedal shaft 6.

The other end of the locking rod 262 penetrates through the perforated hole 261 and comes into contact with a pressure cam 265, which is fixedly mounted on a cam shaft 266. The cam shaft 266 is rotatably mounted to the projecting portion 4b of the pedal arm 4, and an L-shaped lever 267 is fixedly mounted on the cam shaft 266 to rotate the cam shaft 266.

In the present embodiment, four slits are formed on the outer circumference of the pedal shaft. Two slits A and C are arranged at both ends of a diagonal line collinear with a bisector line which longitudinally bisects the pedal arm 4, and the remaining two slits B and D are spaced apart from the slit A in opposite directions by an angle between 30° and 40°, preferably, an angle of approximately 35°. Here, the slit A is a slit located farthest to the pedal 2.

The clutch mechanism 250 configured as stated above permits the pedal arm 4 to rotate freely around the pedal shaft 6 in a state wherein the locking rod 262 is not pressed by the pressure cam 265. In such a non-pressed state of the locking rod 262, the pedal arm 4 is rotated so that one end of the locking mechanism 260 is matched to one of the slits A to D formed on the outer circumference of the pedal shaft 6, and then the pressure cam 265 is operated to press the locking rod 262. Thereby, if the end of the locking mechanism 260 is inserted in one of the slits, the pedal arm 4 is fixed on and rotates with the pedal shaft 6.

Accordingly, the clutch mechanism 250 permits the left pedal to be positioned at specific locations corresponding to the slits A to D, enabling the left pedal to operate in a variety of pedaling modes which will be described below.

That is, considering first the case that the fitting 38 is inserted in the first receiving space 211, if the left pedal is fixedly positioned at the slit A under operation of the clutch mechanism 250, the left and right pedal arms 4 and 5 form an angle of 180° with each other, thereby enabling forward pedaling and reverse pedaling as shown in FIG. 2. If the left pedal is fixedly positioned at the slit C, the left and right pedal arms 4 and 5 are positioned in parallel to each other, thereby enabling forward kangaroo pedaling and reverse kangaroo pedaling as shown in FIG. 5. Further, if the left pedal is fixedly positioned at the slit B or D, one of the pedal arms extends upward and the other one extends downward upon stair climbing driving, and both the pedal arms are inclined forward or backward by an angle of approximately 35°. Although not shown in FIG. 2, this enables scissors left side pedaling and scissors right side pedaling by forward pedaling and reverse pedaling, facilitating stair climbing of the bicycle.

The shifting mechanism 280 is disposed at one side of the base portion 4a of the pedal arm 4 close to the pedal, so as to move forward or backward along the pedal arm 4 in three stages.

For this, the shifting mechanism 280 includes a carrier 290 which moves along with the fitting 38 which will be selectively positioned at a predetermined position of the positional disc 210, and a controller 270 used to transfer the carrier 290 in three stages.

In order to allow the carrier 290 of the shifting mechanism 280 to slidably move in three stages along a portion 4c of the pedal arm 4 next to the base portion 4a, the portion 4c is provided with a rail piece 80 which protrudes toward the positional disc 210 to extend in a longitudinal direction of the pedal arm 4 and is longitudinally formed at opposite upper and lower surfaces thereof with grooves 81, and a dented portion 82 defined at the portion 4c of the pedal arm 4 opposite to the rail piece 80 in order to limit vertical motion range of the carrier 290 and to detachably attach the carrier 290 to the portion 4c of the pedal arm 4.

The carrier 290 has a channel shaped member 290a, which consists of a pair of legs 292, a base portion 294, and a distance keeper piece 295. The legs 292 are longitudinally formed throughout their facing inner surfaces with protrusions 291, respectively, which are shaped and sized to be slidably inserted in the grooves 81 of the rail piece 80. The connecting base portion 294 has a recess 293 formed at an inner surface thereof facing an end of the rail piece 80. The recess 293 also faces a recess 84 formed at the end of the rail piece 80 so as to receive a pressure spring 83 in cooperation with the recess 84. In a received state, the pressure spring 83 protrudes toward the pedal. The distance keeper piece 295 is integrally formed at ends of the legs 292 to face the positional disc 210, and serves to constantly keep a distance between both the legs 292 and to support the fitting 38.

For the mounting or dismounting of the channel shaped member 290a relative to the rail piece 80, the carrier 290 further has a stopper member 290b. Both lateral ends of the stopper member 290b are fixed to edges of the legs 292 opposite to the positional disc 210 by means of not shown fasteners. The stopper member 290b is slidably movable in the dented portion 82 by a predetermined distance when it being fitted in the channel shaped member 290a.

The controller 270 is detachably mounted to one of the legs 292 so that it is selectively latched to one of two latch grooves 85, which are formed at an upper surface of the pedal arm 4 so as to be longitudinally spaced apart from each other. Now, the detailed structure of the controller 270 will be explained.

The controller 270 includes a pivoting shaft 271 rotatably fitted in a retainer 296, which is integrally formed to protrude outward from an outer surface of one of the legs 292 of the channel shaped member 290a. A scissor bar 272 is fixed at one end of the pivoting shaft 271 to rotate simultaneously with the pivoting shaft 271. A stopper rod 274 is inserted at one end thereof in a bore 296a of the retainer 296 by interposing a spring 273, and the other end of the stopper rod 274 forms a ball 274a protruding out of the bore 296a, so as to elastically reciprocate in a direction perpendicular to an axis of the pivoting shaft 271. In order to ensure that the ball 274a protrudes outward in an elastically movable manner, a case 270a having an opening 275 is detachably coupled to one of the legs 292. The case 270a is further has a pair of through-holes 276 at opposite sides of the opening 275. The through-holes 276 are spaced apart from the opening 275 by a distance smaller than a distance of both the latch grooves 85. One of the legs 292 is formed with a pair of through-holes 297 which are spaced apart from each other by the same distance as that of the through-holes 276 and are positioned to face the through-holes 276, respectively. Two latches 278 are coupled to the case 270a. Each of the latches 278 has a stepped portion 278a formed at one end thereof. The other end of the latch 278 has the same shape and size as the latch groove 85 of the pedal arm 4 so as to be tightly latched thereinto. The end of the latch 278, formed with the stepped portion 278a, penetrates through an associated one of the through-holes 276 formed at the case 270a with being fixed to a spring 279 interposed between the case 270a and the stepped portion 278a. The latch 278 is formed with a lift holder 278b shaped and sized suitable to catch the scissor bar 272. The controller 270 further has a handlebar H integrally protruding from the center of the scissor bar 272. Using the handlebar H enables the scissor bar 272 to hingedly rotate about the pivoting shaft 271. The handlebar H has a sliding boss which comes into elastic contact with the ball 274a of the stopper rod 274 whenever the scissor bar 272 hingedly rotates to thereby slide over the ball 274a. As a result, the scissor bar 272 can be maintained at its hingedly rotated position so long as the bicyclist does not operate the handlebar H.

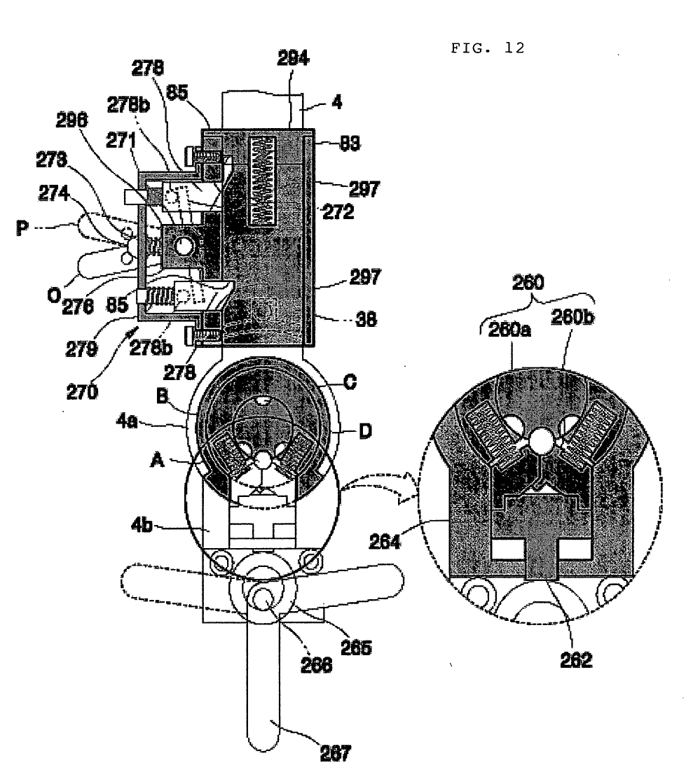

With the configuration of the present embodiment as described above, when the bicyclist locates the handlebar H at a position O as is shown in FIG. 12, the latch 278 close to the pedal shaft 6 is not affected by a pressure force of the scissor arm 272, and is latched at the end thereof to the latch groove 85 close to the pedal shaft 6 upon receiving a force of the spring 279. On the other hand, the latch 278 far away from the pedal shaft 6 is affected by the pressure force of the scissor arm 272 and is unlatched from the latch groove 85 far away from the pedal shaft 6. In this case, the fitting 38 is inserted in the first receiving space 211 of the positional disc 210. Here, if the end of the locking mechanism 260 engaged with the clutch mechanism 250 is inserted into one of the slits A to D formed at the pedal shaft 6, this permits to perform a variety of pedaling modes as shown in FIGS. 2 and 5.

When the bicyclist locates the handlebar H at a position P as is shown in FIG. 12, the latch 278 close to the pedal shaft 6 is affected by the pressure force of the scissor arm 272, and is unlatched from the latch groove 85 close to the pedal shaft 6. At the same time, the carrier 290 is moved forward by the pressure spring 83 along the rail piece 80 formed at the pedal arm 4. Then, the latch 278 far away from the pedal shaft 6 is released from the pressure force of the scissor arm 272, and is latched at the end thereof to the latch groove 85 far away from the pedal shaft 6 upon receiving the force of the spring 279. In this case, the fitting 38 is inserted into the third receiving space 213 of the positional disc 210. Here, if the end of the locking mechanism 260 engaged with the clutch mechanism 250 is not inserted into one of the slits A to D formed at the pedal shaft 6, this ensures easy implementation of a variety of pedaling modes as shown in FIG. 7, especially, stair climbing forward and stair climbing backward.

When the bicyclist again locates the handlebar H at the position O, both the latches 278 are unlatched from both the latch grooves 85, and at the same time, the carrier 290 is moved forward by the pressure spring 83 along the rail piece 80 formed at the pedal arm 4 until the stopper member 290b thereof elastically collides with a portion defining the dented portion 82. Thereby, the fitting 38 is inserted in the second receiving space 212 of the positional disc 210. Here, if the end of the locking mechanism 260 engaged with the clutch mechanism 250 is not inserted into one of the slits A to D formed at the pedal shaft 6, this enables implementation of a variety of pedaling modes as shown in FIG. 7.

Further, in the forward moved state of the carrier 290, the bicyclist can locate the fitting 38 in a selected one of the three receiving spaces 211, 212 and 213 by pressing the carrier 290 or the controller 270 toward the pedal shaft 6 by his/her foot, performing a variety of pedaling modes.

As apparent from the above description, the present invention provides a bicycle excellent to provide a wide range of exercise routines for the user in order to tone thighs, hamstrings, calves, abdominal muscles, back and various upper front and side-body muscles without requiring the bicyclist to excessively outstretch his/her legs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A driving apparatus of a multifunctional chain bicycle in which, components of a forward driving arrangement to permit forward motion of the bicycle with either forward or reverse rotation of bicycle's pedals are arranged on the right side of a bicycle's rear wheel shaft and on the right side of a pedal shaft, and components of both stair climbing pedaling arrangement and pedal positional arrangement are arranged on the left side of the pedal shaft and on a left one of two pedal arms,
wherein the forward driving arrangement comprises:
a pedal sprocket fixedly mounted on the pedal shaft and rotating with the pedal shaft;
a front wheel and a rear wheel fixedly mounted on a front wheel hub and a rear wheel hub, respectively;
a rear wheel shaft mounted in the rear wheel hub via bearings so as to rotate in either forward or reverse direction;
a first rear wheel sprocket and a second rear wheel sprocket mounted on a right end of the rear wheel shaft via first and second one-way clutches, respectively, the first and second one-way clutches rotating simultaneously while being caught in only a forward direction;
an idler roller rotatably mounted to a bicycle frame near the rear wheel; and
an endless chain looped around the pedal sprocket as well as the first and second rear wheel sprockets and the idler roller,
wherein the first and second one-way clutches are fixed on the rear wheel shaft via respective bearings, so as to rotate freely in either forward or reverse direction,
wherein the first one-way clutch comes into contact at a first end thereof with the rear wheel hub while being fixed in the forward direction, and the second one-way clutch comes into contact at a first end thereof with a second end of the first one-way clutch while being fixed in the forward direction, and
wherein, when the pedal shaft rotates in the forward direction with forward rotation of the pedals, the endless chain transmits power in an order of the top of the pedal sprocket, the bottom of the pedal sprocket, the top of the first rear wheel sprocket, the bottom of the first rear wheel sprocket, the bottom of the idler roller, the top of the roller, the bottom of the second rear wheel sprocket, the top of the second rear wheel sprocket, and the top of the pedal sprocket as an original starting point.

2. The apparatus as set forth in claim 1, wherein a foot holder device is attached to a respective one of the pedals,
wherein the foot holder device comprises:
a rectangular pedal base rotatably coupled to a first fixing shaft fixedly mounted at a first end thereof to a first end of an associated one of the pedal arms to protrude outward in a lateral direction of the pedal arm;
a holder base having a shape and size suitable to surround three side walls of the pedal base except for a side wall where a strap is disposed, the first fixing shaft rotatably penetrating through a first side wall of the holder base, and an opposite second side wall of the holder base being rotatably penetrated by a second fixing shaft fixedly mounted to the pedal base to thereby permit the holder base, made of a heavy material, to be supported by means of both the fixing shafts;
the strap having a first end coupled to an end of the first side wall of the holder base, penetrated by the first fixing shaft, through female-male coupling, and a second end coupled to an end of the second side wall of the holder base penetrated by the second fixing shaft so as to be readily released in a direction regardless of any pedaling motion, the strap being made of plastic and centrally provided with a length adjuster to allow the overall length of the strap to be adjusted; and
an inverted holder base keeper unit elastically fitted in a cavity defined in the pedal base to penetrate through an outer side wall of the pedal base defining the cavity and to be latched into a recess defined in an inner wall surface of the second side wall of the holder base penetrated by the second fixing shaft, and
wherein a spring is coiled around the second fixing shaft so that an end of the coil spring is affixed to the pedal base and the other end thereof is affixed to the holder base, and a stopper protrudes outward from the outer side wall of the pedal base.

3. The apparatus as set forth in claim 2, wherein the inverted holder base keeper unit includes:
a cylindrical post;
a first rod having a first end fixedly attached to a first circumferential position of the cylindrical post and a second end extending opposite to the cylindrical post to penetrate through a partition wall of the pedal base defining the cavity, a spring being coiled around the first rod between the partition wall and the cylindrical post;
a second rod having a first end fixedly attached to a second circumferential position of the cylindrical post spaced apart from the first circumferential position by an angle of 90°, and a second end extending opposite to the first rod so as to penetrate through the outer side wall of the pedal base defining the cavity, the second rod being integrally formed with a limiter piece to limit the protrusion of the second end of the second rod out of the pedal base; and
a third rod vertically penetrating through a spring vertically inserted in the interior space of the hollow cylindrical post so as to be elastically extendible from the top of the cylindrical post,
wherein, when the holder base is moved from its vertical erected state to its horizontal inverted state, the second rod comes into contact with the rim of the recess at a cam surface formed at the second end thereof to thereby move backward by the cam surface, so as to permit the second end of the second rod to be released from the recess.

4. The apparatus as set forth in claim 2 or 3, wherein the end of the second side wall of the holder base penetrated by the second fixing shaft is provided with a box-shaped receiving member, the receiving member being opened toward the rear wheel and being closed in an opposite direction in the erected state of the holder base,
wherein a cylindrical insert is inserted in a slot defined in an outer wall of the receiving member while being compressively fixed by a plate spring affixed to the outer wall of the receiving member by means of fasteners, the inserted cylindrical insert protruding toward an interior space of the receiving member, and
wherein the second end of the strap has a shape and size corresponding to the interior space of the receiving member.

5. The apparatus as set forth in claim 1, wherein the stair climbing pedaling arrangement comprises:
first and second sprockets mounted on a left end of the pedal shaft;
first and second idler rollers rotatably mounted to a bicycle frame; and
an endless chain looped around the first and second idler rollers and the first and second sprockets,
wherein the first sprocket is fixed on the pedal shaft, and the second sprocket is freely rotatable on the pedal shaft via a bearing, and
wherein the endless chain is looped around the idler rollers and the sprockets in an order of the top of the first sprocket, the bottom of the first idler roller, the top of the first idler roller, the top of the second sprocket, the bottom of the second sprocket, the top of the second idler roller, the bottom of the second idler roller, the bottom of the first sprocket, and the top of the first sprocket as an original starting position.

6. The apparatus as set forth in claim 1, wherein the pedal positional arrangement comprises:
a positional disc coupled to the second sprocket so as to rotate freely on the pedal shaft;
a clutch mechanism provided at a base portion of the pedal arm and adapted to rotate the pedal arm on the pedal shaft, separately from or simultaneously with the pedal shaft; and
a shifting mechanism disposed near the base portion of the pedal arm to close to the left pedal and adapted to shift a fitting in three stages, the fitting being selectively positioned at a predetermined portion of the positional disc.

7. The apparatus as set forth in claim 6, wherein the positional disc includes three receiving spaces to selectively receive the fitting, and the three receiving spaces, communicating with the sprocket, have the same center axis as that of the pedal shaft, but have different perimeters and different radial positions from one another.

8. The apparatus as set forth in claim 7, wherein the three receiving spaces include:
a ring shaped first receiving space positioned radially closest to a center axis of the pedal shaft;
a second receiving space positioned radially farthest to the center axis of the pedal shaft and having a shape and size corresponding to that of the fitting; and
an annular third receiving space positioned in a radial halfway between the first receiving space and the second receiving space, an imaginary line which extends, starting from a center point of the pedal shaft, over a forward end of the annular third receiving space forming an angle between 15° and 25° with a bisector line which radially bisects the second receiving space, an imaginary line which extends, starting from the center point of the pedal shaft, over a reverse end of the annular third receiving space forming an angle larger than 25° but smaller than 45°.

9. The apparatus as set forth in claim 7 or 8, wherein the positional disc has two radially-extending flat springs fixed at their radial inner ends to a ring-shaped root portion of the second sprocket and provided at their radial outer ends with balls configured to penetrate through respective holes formed at the second sprocket so as to protrude toward the fitting, the flat springs being positioned, respectively, near both the ends of the third receiving space.

10. The apparatus as set forth in claim 6, wherein the clutch mechanism is provided at a first projecting portion of the pedal arm extending, opposite to the left pedal, from the base portion of the pedal arm, the clutch mechanism being rotatably mounted on the pedal shaft via a bearing,
wherein a spring containing case is spline-coupled to an inner circumference of the base portion and is fixed on the pedal shaft,
wherein, in order to prevent unintentional separation of the spring containing case, a cover member comes into contact with the spring containing case and the base portion and is fastened to the base portion by fasteners to thereby be rotatably mounted on the pedal shaft via a bearing,
wherein the spring containing case is radially cut within a range of 90° about the center axis of the pedal shaft opposite to a region, where the left pedal will be mounted, to form an opening, both ends of the case defining the opening being provided with bores so that a pair of springs are inserted therein in a partially protruded state to face each other,
wherein the first projecting portion of the pedal arm defines a receiving space communicating with the opening and serving to receive a locking mechanism, in order to permit vertical movement of the locking mechanism, a locking rod being also slidably received in the receiving space so that a first end thereof comes into contact with the locking mechanism and a second end thereof protrudes out of the receiving space through a hole perforated at the first projecting portion, the hole communicating the receiving space with the outside,
wherein in order to prevent the locking rod from being separated from the locking mechanism, the cover member is formed at part of an outer circumference thereof with a radially protruding separation-preventing piece,
wherein the locking mechanism is divided into two sections, which are shaped and sized so that their first ends are engaged with each other to form a seat portion which will be tightly seated on the end of the locking rod and their second ends are engaged with each other to form a specifically shaped and sized portion suitable to permit the locking mechanism to be inserted into a selected one of plural semi-circular slits formed on an outer circumference of the pedal shaft, and
wherein a second end of the locking rod penetrates through the perforated hole and comes into contact with a pressure cam fixedly mounted on a cam shaft, an L-shaped lever being fixed mounted on the cam shaft.

11. The apparatus as set forth in claim 10, wherein first to fourth slits are formed on the outer circumference of the pedal shaft, the first and third slits being arranged at both ends of a diagonal line collinear with a bisector line which longitudinally bisects the pedal arm, and the second and fourth slits being spaced apart from the first slit in opposite directions by an angle between 30° and 40°.

12. The apparatus as set forth in claim 6, wherein the shifting mechanism includes:
a carrier which moves along with the fitting which will be selectively positioned at the predetermined portion of the positional disc; and
a controller used to transfer the carrier in three stages.

13. The apparatus as set forth in claim 12, wherein a second projection portion of the pedal arm near the base portion opposite to a first projection portion includes:
a rail piece protruding toward the positional disc and extending in a longitudinal direction of the pedal arm, upper and lower surfaces of the rail piece being longitudinally formed with elongated grooves; and
a dented portion opposite to the rail piece and serving to limit vertical motion range of the carrier and to detachably attach the carrier to the second projecting portion of the pedal arm,
wherein the carrier includes:
a channel shaped member consisting of a pair of legs, a base portion, and a distance keeper piece, the legs being longitudinally formed throughout their facing inner surfaces with protrusions, respectively, shaped and sized to be slidably inserted in the elongated grooves of the rail piece, the connecting base portion having a first recess formed at an inner surface thereof facing a first end of the rail piece to face a second recess formed at the first end of the rail piece so as to compressively receive a pressure spring in cooperation with the second recess, the distance keeper piece being integrally formed at ends of the legs to face the positional disc and serving to constantly keep a distance between both the legs and to support the fitting protruding from a plane of the channel shaped member facing the positional disc; and
a stopper member used to mount or dismount the channel shaped member to or from the rail piece, both ends of the stopper member being fixed to edges of the legs opposite to the positional disc by means of fasteners, the stopper member being slidably movable in the dented portion by a predetermined distance when it is fitted in the channel shaped member, and
wherein the controller is detachably mounted to one of the legs so that it is selectively latched to one of two latch grooves formed at an upper surface of the pedal arm so as to be longitudinally spaced apart from each other.

14. The apparatus as set forth in claim 13, wherein the controller includes:
a pivoting shaft rotatably fitted in a retainer integrally formed to protrude outward from an outer surface of one of the legs of the channel shaped member;
a scissor bar fixed at one end of the pivoting shaft to rotate simultaneously with the pivoting shaft;
a stopper rod having a first end inserted in a bore of the retainer by interposing a spring and a second end forming a ball protruding out of the bore to thereby elastically reciprocate in a direction perpendicular to an axis of the pivoting shaft;
a case detachably mounted to the leg;
an opening formed at the case in order to ensure that the ball, formed at the second end of the stopper rod, protrudes outward in an elastically reciprocable manner;
a pair of through-holes formed at opposite sides of the opening and spaced apart from the opening by a distance smaller than a distance of both the latch grooves;
a pair of through-holes formed at the leg and spaced apart from each other by the same distance as that of the through-holes of the case to face the through-holes of the case, respectively;
two latches each having a first end formed with a stepped portion and a second end shaped and sized to be latched to an associated one of the latch grooves formed at the pedal arm, the first end of the latch penetrating through an associated one of the through-holes formed at the case with being fixed to a spring interposed between the case and the stepped portion, the latch being formed with a lift holder shaped and sized suitable to catch the scissor bar; and
a handlebar integrally protruding from a center of the scissor bar to permit the scissor bar to hingedly rotate about the pivoting shaft,
wherein the handlebar has a sliding boss coming into elastic contact with the ball of the stopper rod whenever the scissor bar hingedly rotates to thereby slide over the ball, thereby allowing the scissor bar to be maintained at its hingedly rotated position so long as the handlebar is not operated.
